(19) United States
(12) Patent Application Publication
(10) Pub. No.: US 2016/0346908 A1
(43) Pub. Date: Dec. 1, 2016

(54) Modular Screw Driver

(71) Applicant: Chia-Chun Liu, TAICHUNG (TW)

(72) Inventor: Chia-Chun Liu, TAICHUNG (TW)

(21) Appl. No.: 14/726,351

(22) Filed: May 29, 2015

(51) Int. Cl. B25B 23/00; B25G 3/00; B25B 15/02

(52) U.S. Cl. CPC B25B 23/0035; B25B 15/02; B25G 3/00

(57) ABSTRACT

A modular screw driver includes handle, a lining and a shaft. The handle includes a non-circular bore. The lining includes a profile in compliance with the bore. The shaft includes an operative tip at an end and an insert at another end. The insert is inserted and trapped in the lining.

### BACKGROUND OF INVENTION

1. Field of Invention

The present invention relates to a screw driver and, more particularly, to a modular screw driver.

2. Related Prior Art

A conventional screw driver includes a shaft and a handle. The shaft is a metal element made with fins at a rear end by forging. The handle is a plastic element made by injection molding. The rear end of the shaft, which is formed with the fins, is inserted in the handle so that the shaft is rotatable by operating the handle.

A mold is used in the injection molding. The mold includes a cavity in compliance with the profile of the handle. Pressurized liquid of a plastic material is filled in the cavity of the mold. Thus, a front end of the shaft is generally held by an operator while the rear end of the shaft is inserted in the cavity of the mold. When the plastic material is cured, the mold is removed from the handle. Thus, the screw driver is completed.

The shaft is often shaken relative to the handle in the injection molding. Thus, the axis of the shaft is not aligned with the axis of the handle when the screw driver is completed, and this is not desirable. Such a screw driver is operable inconvenient.

Moreover, many machines are required to make such a conventional screw driver. And these machines impose risks on the safety of the operator.

The present invention is therefore intended to obviate or at least alleviate the problems encountered in prior art.

### SUMMARY OF INVENTION

It is the primary objective of the present invention to provide a modular screw driver.

To achieve the foregoing objectives, the modular screw driver includes handle, a lining and a shaft. The handle includes a non-circular bore. The lining includes a profile in compliance with the bore. The shaft includes an operative tip at an end and an insert at another end. The insert is inserted and trapped in the lining.

Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is an exploded view of a modular screw driver according to the first embodiment of the present invention;

FIG. 2 is a cross-sectional view of a handle of the modular screw driver shown in FIG. 1;

FIG. 3 is a perspective view of a lining of the modular screw driver shown in FIG. 1;

FIG. 4 is another exploded view of the modular screw driver illustrated in FIG. 1;

FIG. 5 is a cut-away view of the modular screw driver shown in FIG. 1;

FIG. 6 is an exploded view of a modular screw driver according to the second embodiment of the present invention;

FIG. 7 is a cross-sectional view of the modular screw driver illustrated in FIG. 6;

FIG. 8 is a partial, cross-sectional view of a handle of a modular screw driver according to the third embodiment of the present invention; and

FIG. 9 is a perspective view of a lining of a modular screw driver according to the fourth embodiment of the present invention.

### DETAILED DESCRIPTION OF EMBODIMENTS

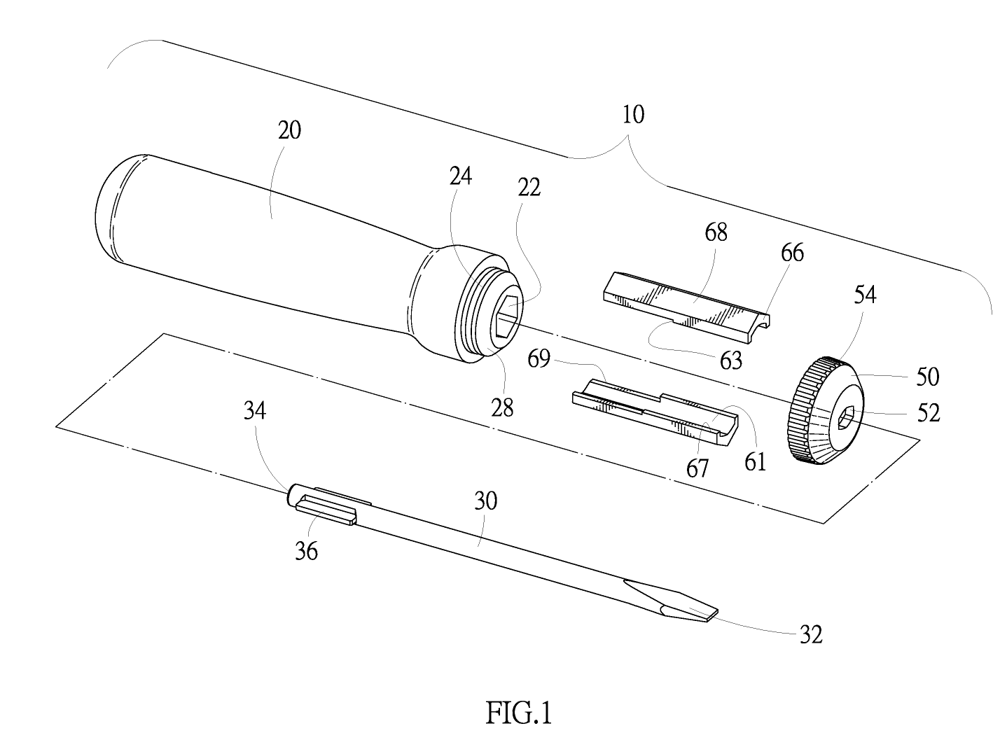

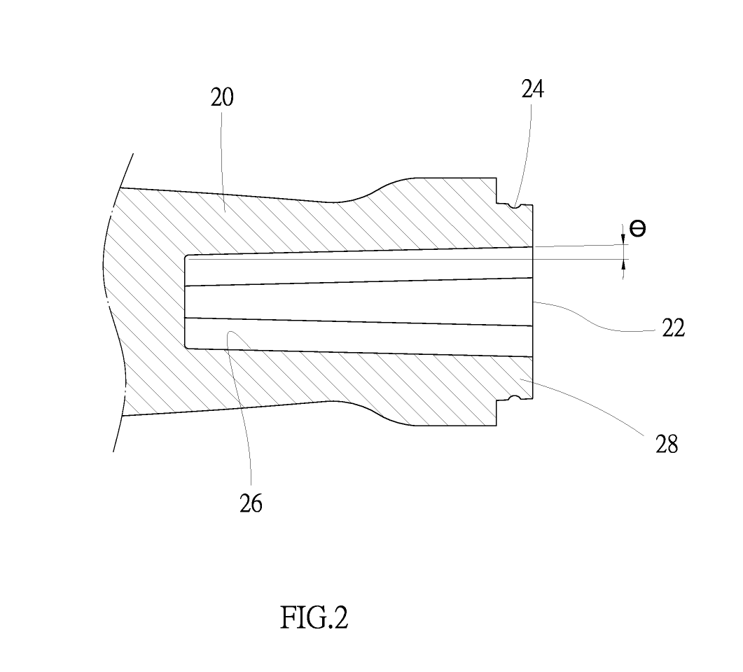

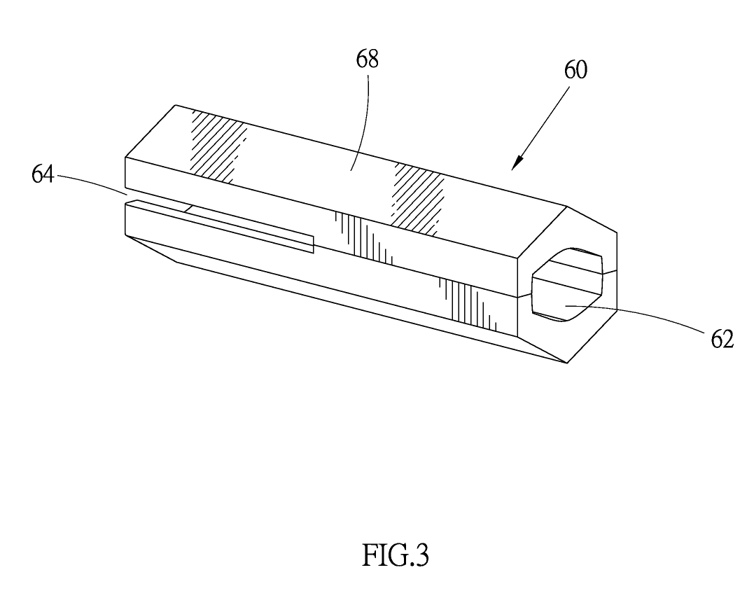

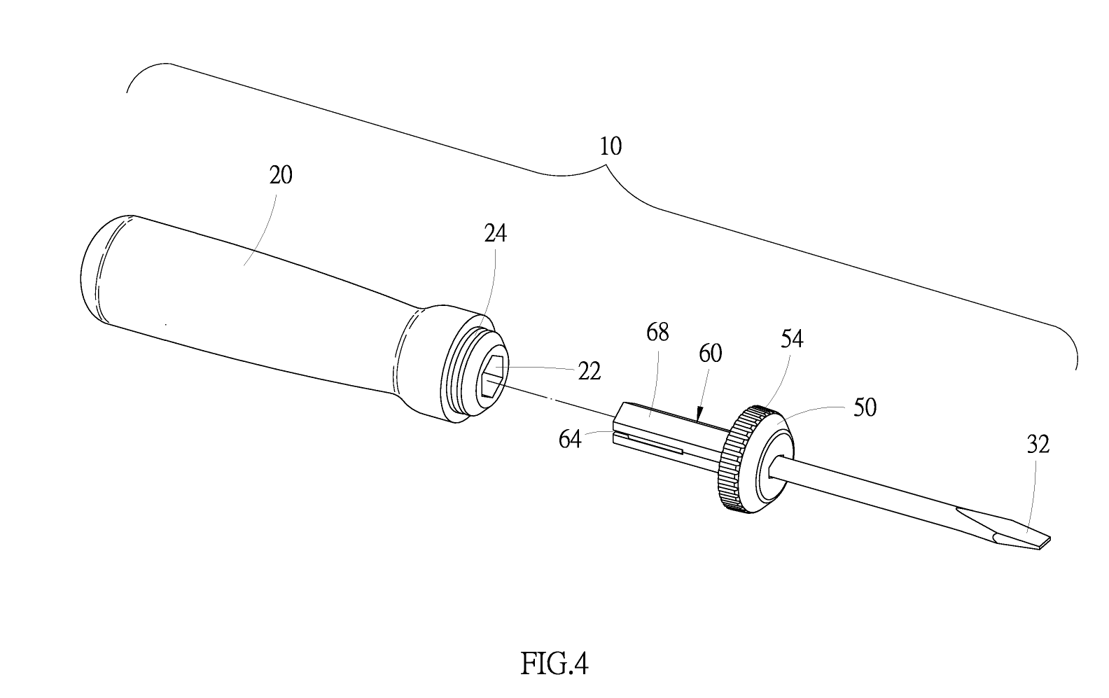

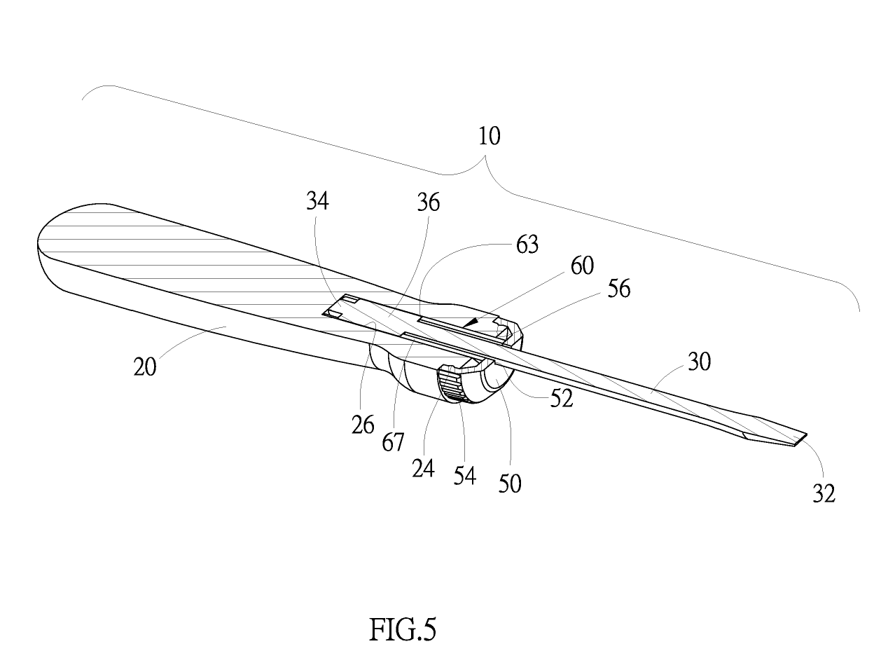

Referring to FIGS. 1 through 5, a modular screw driver 10 includes a handle 20, a shaft 30, a ring 50 and a lining 60 in accordance with a first embodiment of the present invention.

The handle 20 includes a connection portion 28 formed at an end. The connection portion 28 of the handle 20 includes a bore 22 made therein and an annular groove 24 made in an external face thereof. The bore 22 is a hexagonal bore, i.e., there are six facets 26 around the bore 22. Each of the facets 26 extends at an angle θ from the axis of the bore 22 so that an open end of the bore 22 is larger than a closed end of the bore 22. The bore 22 can be any other non-circular bore.

The shaft 30 is a circular shaft formed with an operative tip 32 at an end and an insert at another end. The operative tip 32 is a flat blade as shown. The operative tip 32 can however be a Phillips head, a socket or in any other proper configuration for transmitting torque. The insert 34 is formed with two fins 36. The fins 36 extend transversely from the insert 34 in opposite directions. The insert 34 can be inserted in the bore 22 of the handle 20.

The ring 50 includes an aperture 52 centrally made therein. The ring 50 includes an anti-skid pattern 54 formed on an external face and an annular rib 56 on an internal face. The aperture 52 is an oval aperture, made with a long axis and a short axis. The long axis of the aperture 52 extends longer than a distance between the tips of the fins 36. The short axis of the aperture 52 extends shorter than a diagonal length of the bore 22 but longer than the diameter of the shaft 30.

The lining 60 is made with a hexagonal profile that includes the facets 68 in compliance with the facets 26. That is, each of the facets 68 extends at an angle θ from the axis of the lining 60.

The lining 60 consists of two identical strips 66 each including an internal face 61 and an external face (not numbered). The internal face 61 is a concave face in which a recess 62 is made. The external face consists of several facets 68. Each of the strips 66 further includes two high edges 67, two low edges 69 and two shoulders 63 each formed between a corresponding one of the high edges 67 and a corresponding one of the low edges 69.

When the strips 66 are joined together, the high edges 67 of one of the strips 66 are in contact with the high edges 67 of the other strip 66 while two slits 64 are made between the low edges 69 of the strips 66. Each of the slits 64 includes a closed end made by the shoulders 63. The recesses 62 together become a cylindrical space (not numbered) for receiving the insert 34 of the shaft 30. The fins 36 are inserted in the slits 64 and limited by the shoulders 63.

The lining 60 and the shaft 30 are inserted in the bore 22 of the handle 20. The deeper the lining 60 is inserted in the bore 22 of the handle 20, the firmer the facets 68 of the lining 60 are pressed against the facets 26, which extend around the bore 22 of the handle 20. Thus, the shaft 30 cannot easily be disengaged from the handle 20.

The ring 50 is engaged with the connection portion 28 of the handle 20. The annular rib 56 is inserted in the annular groove 24 to keep the ring 50 on the connection portion 28 of the handle 20. The ring 50 keeps the insert 34 of the shaft 30 and the lining 60 in the handle 20 and provides an aesthetically pleasant look. The ring 50 further provides a neat and smooth profile that would not cut a user.

The shaft 30 extends through the aperture 52 of the ring 50. The operative tip 32 is exposed to the exterior of the handle 20. Hence, the operative tip 32 can be engaged with a screw or nut, and the screw or nut can be rotated by rotating the handle 20.

When the handle 20 is rotated, the facets 68 of the lining 60 are pressed by the facets 26 of the bore 22 so that the fins 36 of the insert 34 of the shaft 30 are clamped by the low edges 69 of the strips 66. This facilitates the transmission of torque to the shaft 30 from the handle 20 via the lining 60.

Advantageously, the structure of the modular screw driver 10 is simple, and the production is easy, and the yield of production is high because of modulation.

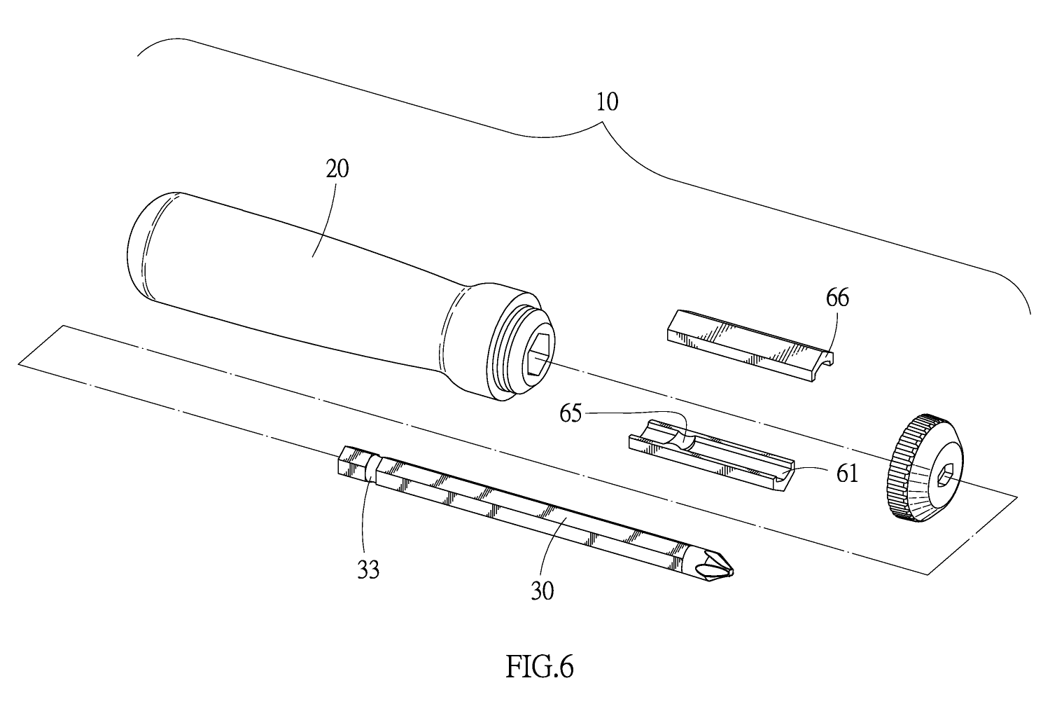

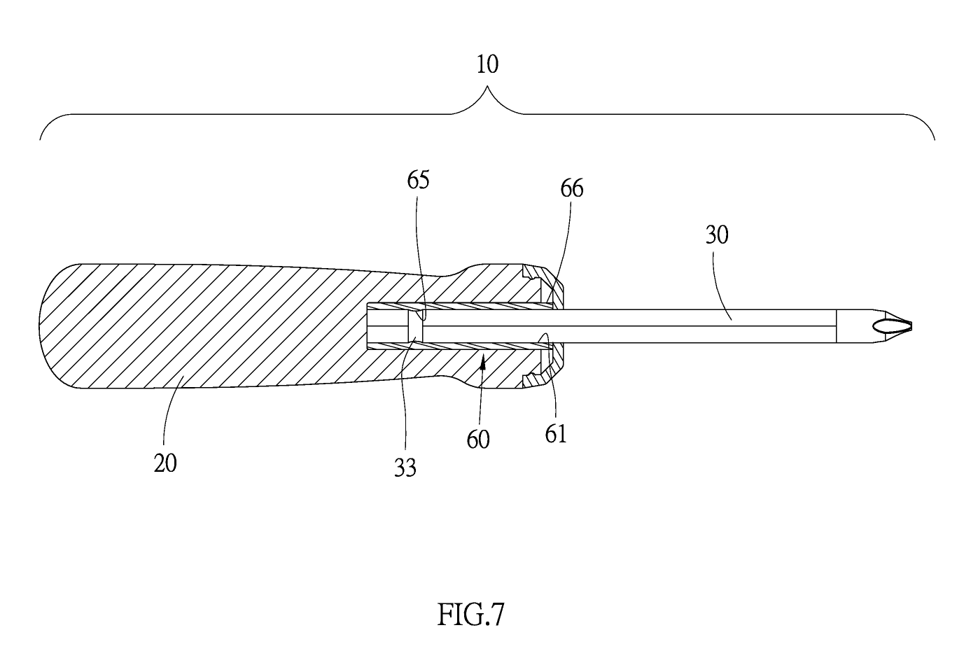

Referring to FIGS. 6 and 7, there is a modular screw driver 10 according to a second embodiment of the present invention. The second embodiment is identical to the first embodiment except for several things. Firstly, each of the strips 66 includes a rib 65 instead of the shoulders 63. That is, each of the strips 66 includes two rectilinear edges in contact with that of the other strip 66, thus eliminating the slits 64. Secondly, the insert 34 of the shaft 30 is made with an annular groove 33 instead of the fins 36. The annular groove 33 receives the ribs 65 as the insert 34 of the shaft 30 is inserted in the lining 60. Thirdly, the shaft 30 is made with a hexagonal profile and the lining 60 is made with a hexagonal internal face in compliance with the hexagonal profile of the shaft 30. Thus, the shaft 30 can only be rotated together with the lining 60.

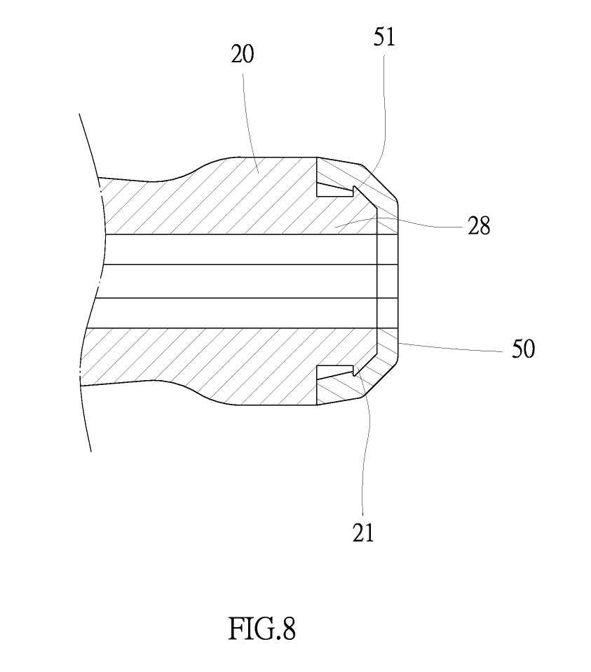

Referring to FIG. 8, a handle 20 and a ring 50 are used in a modular screw driver according to a third embodiment of the present invention. The third embodiment is identical to the second embodiment except for several things. Firstly, the handle 20 includes a barb 21 that extends around the connection portion 28 thereof instead of the annular groove 24. Secondly, the ring 50 includes a barb 51 that extends on an internal face thereof for a circle instead of the annular rib 56. The barb 51 is engaged with the barb 21 to keep the ring 50 on the connection portion 28 of the handle 20.

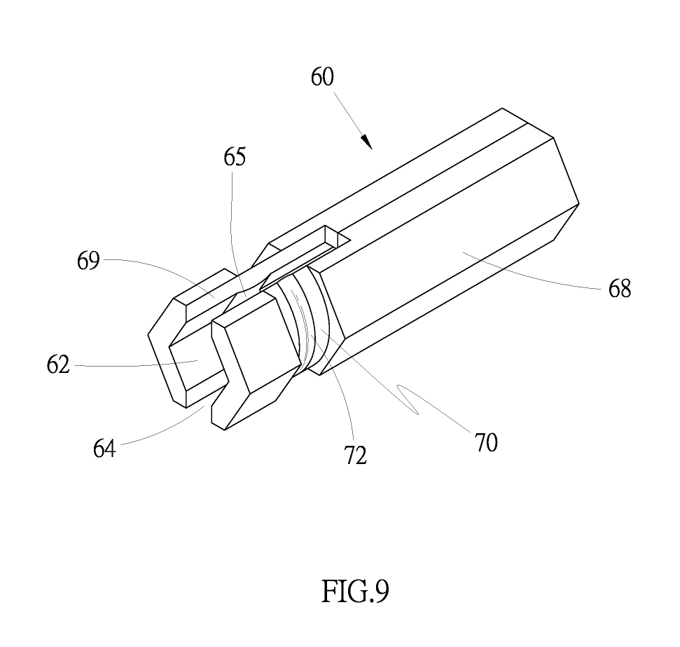

Referring to FIG. 9, the lining 60 further includes an annular groove 70 made in an external side and another annular groove 72 made in the floor of the annular groove 70 according to a fourth embodiment of the present invention. That is, the annular groove 72 is a deeper annular groove in communication with the annular groove 70. The lining 60 is more resilient with the annular grooves 70 and 72 than without. Thus, the insertion of the lining 60 into the handle 20 is easier with the annular grooves 70 and 72 than without.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A modular screw driver comprising:
a handle comprising a non-circular bore;
a lining comprising a profile in compliance with the bore; and
a shaft comprising an operative tip at an end and an insert at another end, wherein the insert is inserted and trapped in the lining.

2. The modular screw driver according to claim 1, wherein the shaft comprises at least one fin extending from the insert, wherein the lining comprises at least one slit for receiving the fin of the shaft.

3. The modular screw driver according to claim 1, wherein the shaft comprises an annular groove in the insert, wherein the lining comprises a rib inserted in the annular groove of the shaft.

4. The modular screw driver according to claim 1, wherein the lining comprises at least two strips joined together, wherein each of strips comprises a concave internal face.

5. The modular screw driver according to claim 4, wherein the shaft comprises at least one fin extending from the insert, wherein each of the strips comprises at least one low edge, wherein the slit is made between the low edges of the strips when the strips are joined.

6. The modular screw driver according to claim 4, wherein the shaft comprises an annular groove in the insert, wherein the lining comprises at least one rib inserted in the annular groove.

7. The modular screw driver according to claim 1, comprising a ring engaged with the handle to keep the insert of the shaft in the handle, wherein the ring comprises an aperture for receiving the shaft.

8. The modular screw driver according to claim 7, wherein the operative tip of the shaft is placed out of the handle.

9. The modular screw driver according to claim 7, wherein the handle comprises a connection portion inserted in and engaged with the ring.

10. The modular screw driver according to claim 9, wherein the handle comprises an annular groove in an external face of the connection portion thereof, wherein the ring comprises an annular rib inserted in the annular groove.

11. The modular screw driver according to claim 9, wherein the handle comprises a barb on an external face of the connection portion thereof, wherein ring comprises a barb engaged with the barb of the handle.

12. The modular screw driver according to claim 11, wherein at least one of the barb of the handle and the barb of the ring extends for a circle.

13. The modular screw driver according to claim 1, wherein the lining comprises a first annular groove made in an external side.

14. The modular screw driver according to claim 1, wherein the lining comprises a deeper second annular groove in communication with the first annular groove.
